(19) United States
(12) Patent Application Publication
(10) Pub. No.: US 2014/0339306 A1
(43) Pub. Date: Nov. 20, 2014

(54) DELIVERY METHOD WITH AUTOMATIC CERTIFICATION

(71) Applicant: THANK YOU MY FRIENDS CORPORATION, New Taipei City (TW)

(72) Inventors: CHUNG-YU LIN, NEW TAIPEI CITY 220 (TW); SHIH-CHIEH HUANG, NEW TAIPEI CITY 220 (TW)

(73) Assignee: THANK YOU MY FRIENDS CORPORATION, New Taipei City (TW)

(21) Appl. No.: 14/272,776

(22) Filed: May 8, 2014

(30) Foreign Application Priority Data
May 16, 2013 (TW) 102117320

(51) Int. Cl. G06Q 10/08

(52) U.S. Cl. CPC G06Q 10/087
USPC 235/385

(57) ABSTRACT

The present invention provides a delivery method with automatic certification. The mobile communication device according to present invention reads the device code of the delivery device and transmits the device code and the corresponding event code to the server. The server validates the corresponding commodity of the event code and the device code, transmits the corresponding code of the commodity to the mobile communication device, and deducts from the corresponding stock record according the corresponding code of the commodity. The mobile communication device transmits the corresponding code of the commodity to the delivery device for delivering the commodity. Thereby, commodity delivery is convenient for users. In addition, the human resource consumed in the delivery procedure can be reduced.

### FIELD OF THE INVENTION

The present invention relates generally to a delivery method, and particularly to a delivery method with automatic certification.

### BACKGROUND OF THE INVENTION

In general automatic control is the operational model adopted most enterprises in the regard of saving human resource. Examples of automatic trading machines well know to the public include automatic vending machines and automatic tell machines. An automatic vending machine is a fully automatic control system used for vending products. Without salespersons and service personnel seen in general stores, the labor cost of salespersons can saved, which raises the profit of selling products. In addition, automatic vending machines can provide 24-hour sales service; the power consumption of a 24-hourly operative automatic vending machine is also less than that of a normal store operating 24-hourly. Thereby, a substantial amount of expenditure on electricity can be saved. Consequently, automatic vending machines have replaced the functions of general store in selling some products, such as drink and snacks.

Automatic teller machines are fully automatic for saving human resources in the business of 24-hour cash withdrawal or deposit. Hence, teller can be allocated for other bank or postal saving business. Likewise, the power consumption of a 24-hourly operative automatic teller machine is less than that of a bank or post office operating 24-hourly. Accordingly, automatic tell machines share most of cash withdrawal or deposit business in general banks or post offices.

Besides, due to the prosperous development of network technologies, networks are not limited to the communication between computers. Instead, following the announcement of mobile communication protocols, mobile network media combines multiple service mechanisms. Moreover, as virtual trading mechanisms are developed on networks, people no longer need to carry a great amount of cash outdoors; even in their homes, commodities still can be ordered or vended.

Nonetheless, the automatic vending machines or automatic tell machines described above are not integrated with mobile communication mechanisms, leading to people's inconvenience in usage. For example:
1. No certification mechanism: The delivery certificate adopted by delivery devices is a one-time certificate. Thereby, if a person loses the certificate, he loses the right to take delivery. If a person finds the delivery certificate lost by others on the road, for the cases of bearer delivery, he could take the delivery assuming others' identities. Once ATM cards for automatic teller machines are taken by others, cash withdrawal can be done directly if the correct passwords are known. No subsequent certification is required. Hence, the cash will be withdrawn by others.
2. No other trading mechanism: Except for cash or credit cards, there is no other trading mechanism for automatic vending machines. In addition, those automatic vending machines supporting credit-card mechanism requires network connections. Taking delivery from a delivery device can be done by a delivery card only; transaction of cash withdrawal or deposit using an automatic tell machine can only be done by inserting an ATM card into the slot. Thereby, if the corresponding ATM card, credit card, or delivery card is not carried, it is not possible to withdraw cash, shop, or take delivery.

Accordingly, the present invention provides a delivery method with automatic certification, which improves the limited trading methods in the automatic trading mechanisms according to the prior art. In addition, certifications besides passwords are provided for preventing the problem of taking delivery or usage assuming others' identities.

### SUMMARY

An objective of the present invention is to provide a delivery method with automatic certification, which provides a real-time certification mechanism so that people can take delivery of commodities timely and validate the delivered commodities accordingly.

In order to achieve the objective and effect described above, the present invention discloses a delivery method with automatic certification. The steps comprise reading and sending a device code of a delivery device to a mobile communication device; transmitting the device code and an event code to a server; the server validating the commodity according to the event code and the device code and reading a serial-number code corresponding to the commodity; transmitting the serial-number code to the mobile communication device, and deducting the commodity from the commodity stock according to the unique serial-number code concurrently; transmitting the serial-number code to the delivery device; and matching the serial-number code according to a reference code stored in the delivery device for releasing the corresponding commodity. The present invention provides a real-time certification mechanism for limited-quantity commodities, so that people can take delivery of the stock limited-quantity commodities in the delivery device through the mobile communication device. Accordingly, people can take delivery of commodities via the real-time certification mechanism. In addition, the applications of automatic trading mechanism can be further provided for facilitating commodity trading with convenience.

Besides, the present provides another delivery method with automatic certification. The difference with the previous embodiment is that the server can further be used for providing a list, including at least a commodity code of non-limited-quantity commodities. Thereby, the server transmits the commodity code to the mobile communication device and deducts the stock of the corresponding commodity according to the event code. Accordingly, the present invention can further reduce the cost of endowing delivery devices with intelligence by using the server to control the delivered quantity of commodities.

### BRIEF DESCRIPTION OF THE DRAWINGS

FIG. 1 shows a schematic diagram of device validation according to an embodiment of the present invention;

FIG. 2 shows a schematic diagram of commodity delivery according to an embodiment of the present invention;

FIG. 3 shows a schematic diagram of reading the device code via near field communication (NFC) according to the present invention;

FIG. 4 shows a schematic diagram of reading the device code via radio frequency identification (RDID) according to the present invention;

FIG. 5 shows a schematic diagram of reading the device code via graphic identification according to the present invention;

FIG. 6 shows a flowchart according an embodiment of the present invention;

FIG. 7 shows a flowchart according another embodiment of the present invention;

FIG. 8 shows a schematic diagram of device validation according to another embodiment of the present invention;

FIG. 9 shows a schematic diagram of transaction validation according to another embodiment of the present invention;

FIG. 10 shows a schematic diagram of commodity delivery according to another embodiment of the present invention;

FIG. 11 shows a flowchart according another embodiment of the present invention; and

FIG. 12 shows a flowchart according another embodiment of the present invention.

### DETAILED DESCRIPTION

In order to make the structure and characteristics as well as the effectiveness of the present invention to be further understood and recognized, the detailed description of the present invention is provided as follows along with embodiments and accompanying figures.

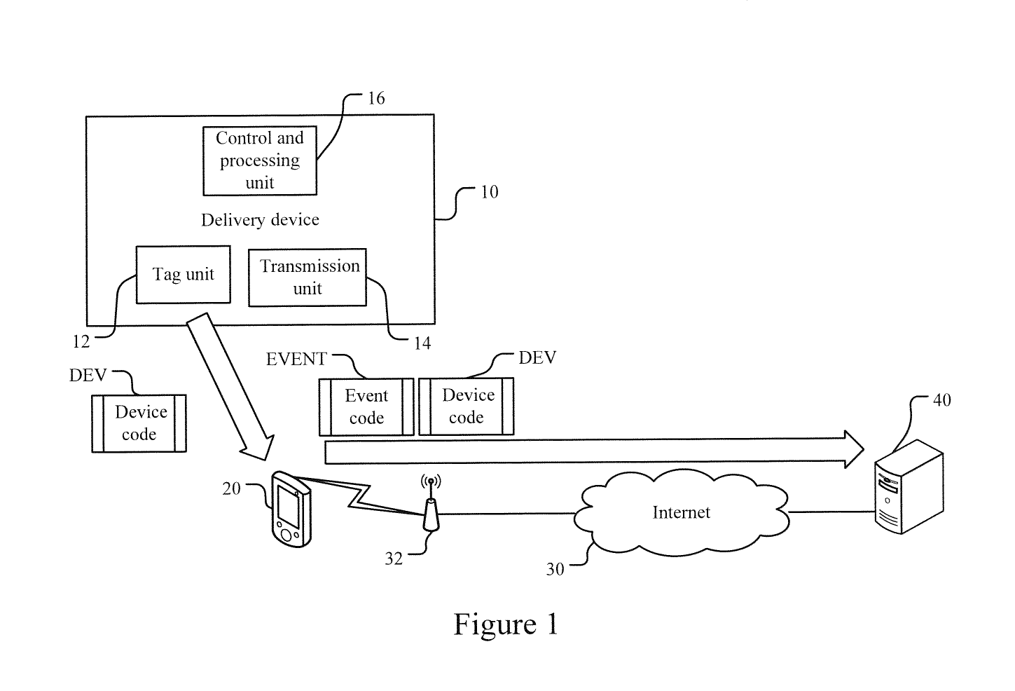

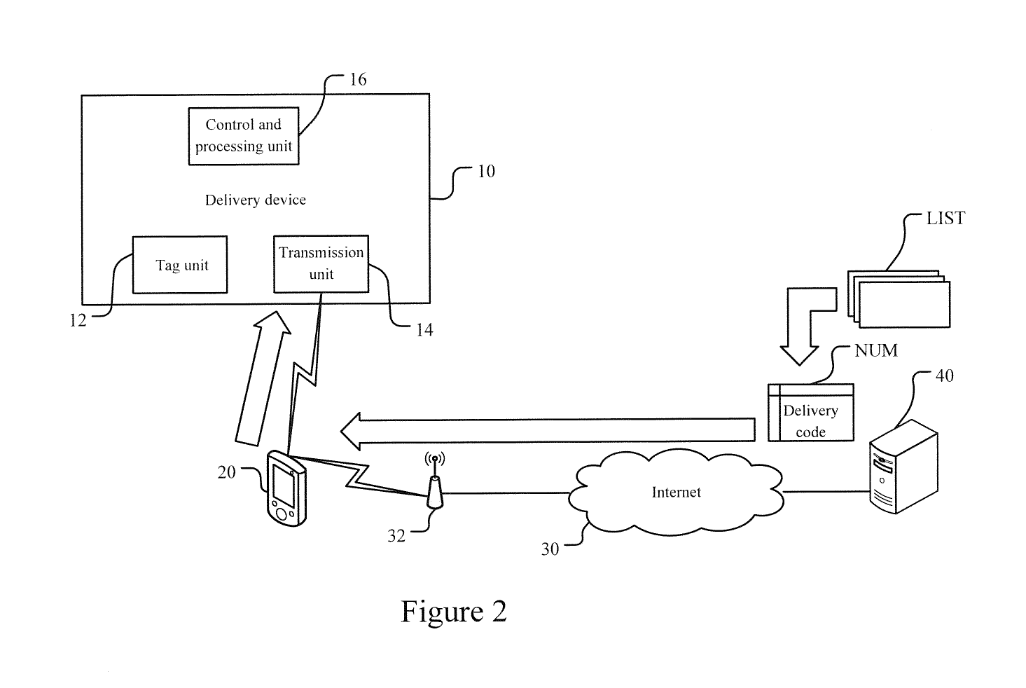

Please refer to FIG. 1 and FIG. 2, which show schematic diagrams of device validation and commodity delivery according to an embodiment of the present invention. As shown in FIGS. 1 and 2, the delivery system for the delivery method with automatic certification according to the present invention comprises a delivery device 10, a mobile communication device 20, and a commodity server 40. In addition, the delivery device 10 has a tag unit 12, a transmission unit 14, and a control and processing unit 16. The mobile communication device 20 is connected to the Internet 30 via a network node 32. The commodity server 40 is also connected to the Internet 30. The network node 32 can be a wireless access point or a mobile network base station.

In FIG. 1, the mobile communication device 20 reads a device code DEV, such as a bar code or a QR code, accessed by the tag unit 12. Together with an event code EVENT, the codes are transmitted to the commodity server 40 through the Internet 30. The event code EVENT includes a serial number of the mobile communication device 20, or a gift code contained in a gift activity message or an activity code contained in a preferential activity corresponding to a store.

As shown in FIG. 2, the commodity server 40 validates correctness of the device code DEV and the event code EVENT, and reads a corresponding list LIST given that the event code shows no usage record and there is stock in the delivery device 10. The list LIST enumerates corresponding delivery codes NUM of all commodities displayed. Hence, the commodity server 40 can select the corresponding delivery code NUM from the list LIST according to the event code EVENT and transmit the delivery code NUM to the mobile communication device 20. In addition, the commodity server 40 deducts the corresponding commodity from the stock record according to the delivery code NUM. The delivery code NUM can be a unique code corresponding to a unique commodity. For example, it can be a seat code of a concert or a movie ticket. Alternatively, it can be a code of commodity type and quantity for corresponding to a non-unique commodity such as a pen, a keyboard, or a mouse.

After the mobile communication device 20 receives the delivery code NUM, the delivery code NUM is input to the transmission unit 14 of the delivery device 10. The transmission unit 14 then transmits the delivery code NUM to the control and processing unit 16 of the delivery device 10. The delivery device 10 reads the built-in list and compares with the delivery code NUM for validating the type and quantity of the commodity to be delivered. Thereby, the commodity can be release according to the delivery code NUM.

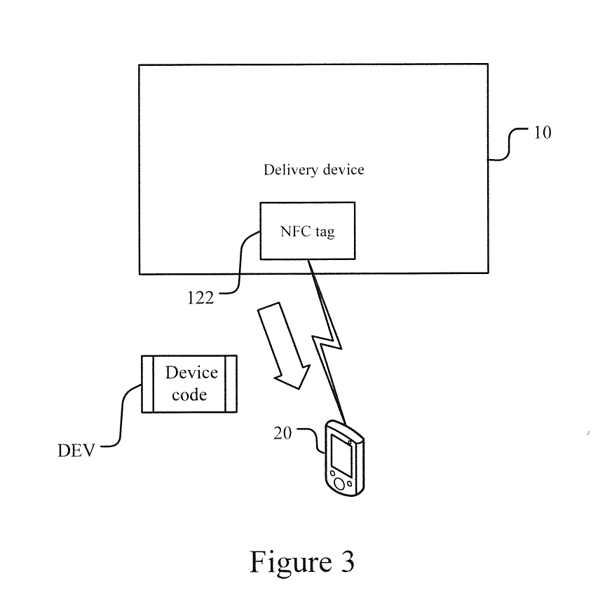

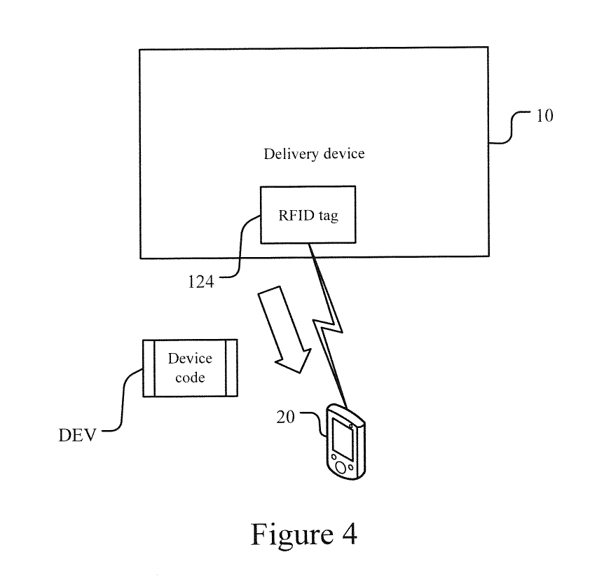

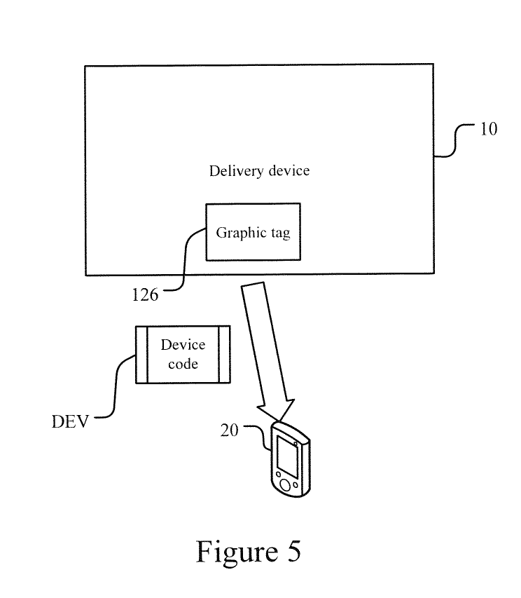

As shown in FIGS. 3 to 5, the device code DEV set in the tag unit 12 of the delivery device 10 according to the present invention can be stored in the form of an electronic or a graphic tag. In FIG. 3, the mobile communication device 20 and the NEC tag 122 support a NFC protocol. Hence, the mobile communication device 20 is connected to the NFC tag 122 according to the NFC protocol for reading the device code DEV stored in the NFC tag 122. In FIG. 4, the mobile communication device 20 and the RFID tag 124 support an RFID protocol. Hence, the mobile communication device 20 is connected to the RFID tag 124 according to the RFID protocol for reading the device code DEV stored in the RFID tag 124. In FIG. 5, the mobile communication device 20 supports image extraction function and the graphic tag 126 includes a graphic code such as a bar code or a QR code. After the mobile communication device 20 extracts the graphic code using the image extraction function, it decodes the corresponding device code DEV according to the graphic code. In the following, different flows for unique and non-unique commodities are provided for described in detail.

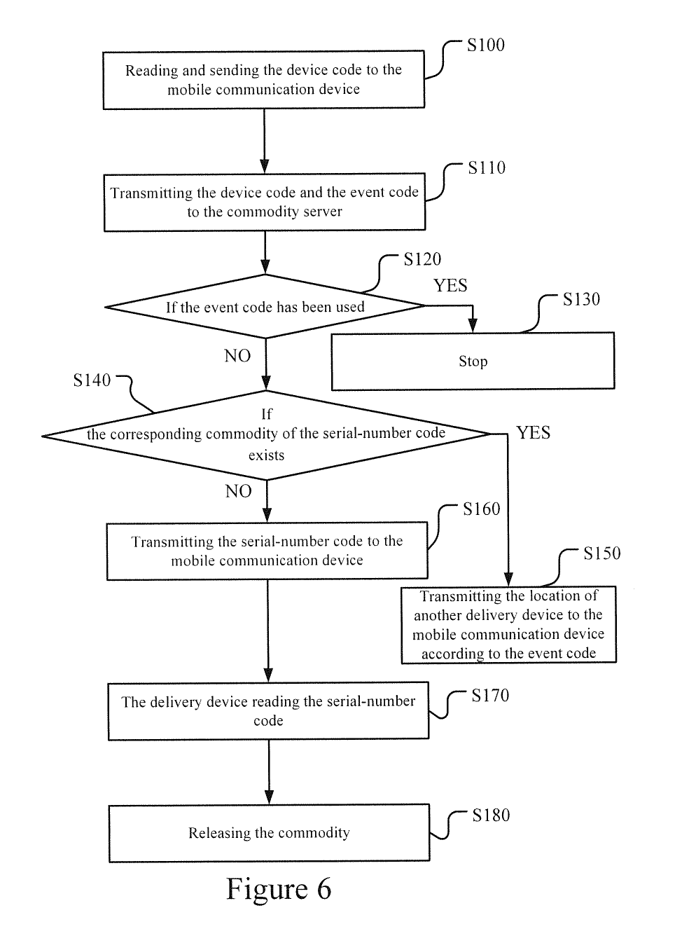

Please refer to FIGS. 1, 2, and 6, which show schematic diagrams of device validation and commodity delivery and a flowchart according to an embodiment of the present invention. As shown in the figure, the delivery method according to the present invention is provided for people to go to a neighboring delivery device 10 for taking delivery of a unique commodity, instead of going to a store specially, and thus gaining convenience in taking delivery of commodities such as free movie tickets. According to the present embodiment, the delivery code NUM is just the serial-number code, which is unique. The delivery method according to the present invention comprises steps of:
S100: Reading and sending the device code DEV to the mobile communication device 20;
S110: Transmitting the device code DEV and the event code EVENT to the commodity server 40;
S120: Confirming if the event code EVENT has been used;
S130: Stop;
S140: Confirming existence of the commodity according the event code EVENT and the device code DEV;
S150: Transmitting the location of another delivery device to the mobile communication device 20 according to the event code EVENT;
S160: Transmitting the serial-number code to the mobile communication device 20;
S170: The delivery device 10 reading the serial-number code; and
S180: Releasing the commodity.

In the step S100, the mobile communication device 20 reads the device code DEV stored in the tag unit 12 of the delivery device 10. The device code DEV is implemented by an electronic tag or a graphic tag. In the step S110, the mobile communication device 10 transmits the read device code DEV, together with the event code EVENT, to the commodity server 40. In the step S120, confirm if the event code EVENT is used. When the event code EVENT is used, the step S130 is executed; if not, the step S140 is executed. In the step 130, the commodity server 40 stops operations and notifies the mobile communication device 20. In the step S140, the commodity server 40 judges if the corresponding commodity of the serial-number code exists in the stock of the delivery device 10. When the commodity server 10 judges that the corresponding commodity of the serial-number code exists in the stock of the delivery device 10, the step S150 is executed; otherwise, the step S160 is executed.

Next, in the step S150, the commodity server 40 reads the location of another delivery device according to the event code EVENT and transmits it to the mobile communication device 20. Thereby, people can know the location of another delivery device by means of the messages received by the commodity server 40. In addition, the commodity server 40 will further submit a supply notification to the vendor of the commodity so that the vendor can supply commodities. In the step S160, the commodity server 40 reads the list LIST and reads the serial-number code corresponding to the event code EVENT and the device code DEV for connecting to the mobile communication device 20 via the Internet 30. Besides, the commodity server 40 deducts the serial-number code of the commodity to be released from the stock record. Take 10 VIP tickets of a concert for example. Each ticket of the concert has a serial-number code corresponding to an event code EVENT. In other words, each serial-number code is unique. Unique event codes EVENT prevent people from taking repeated commodities. Thereby, the deduction method of the commodity stock in the commodity server 40 is to exclude the serial-number code of limited-quantity commodities from the list LIST. Namely, the corresponding serial-number codes in the list LIST are eliminated. Afterwards, in the step S180, the control and processing unit 16 in the delivery device 10 matches a reference code (not shown in the figure) according to the serial-number code and releases the commodity in stock. The reference code is stored in a storage unit (not shown in the figure) of the delivery device 10. By matching the reference code with the serial-number code of the corresponding commodity, the delivery device 10 avoids wrong delivery of commodities to people.

According to the above description, the delivery device 10 enables people to execute certifications of the device code, the event code, and the delivery code via the mobile communication device 20 by themselves for taking delivery of unique commodities. Thereby, manual operations are reduced and the delivered commodities can be confirmed, and thus avoiding delivery assuming other's name or taking delivery of wrong commodities.

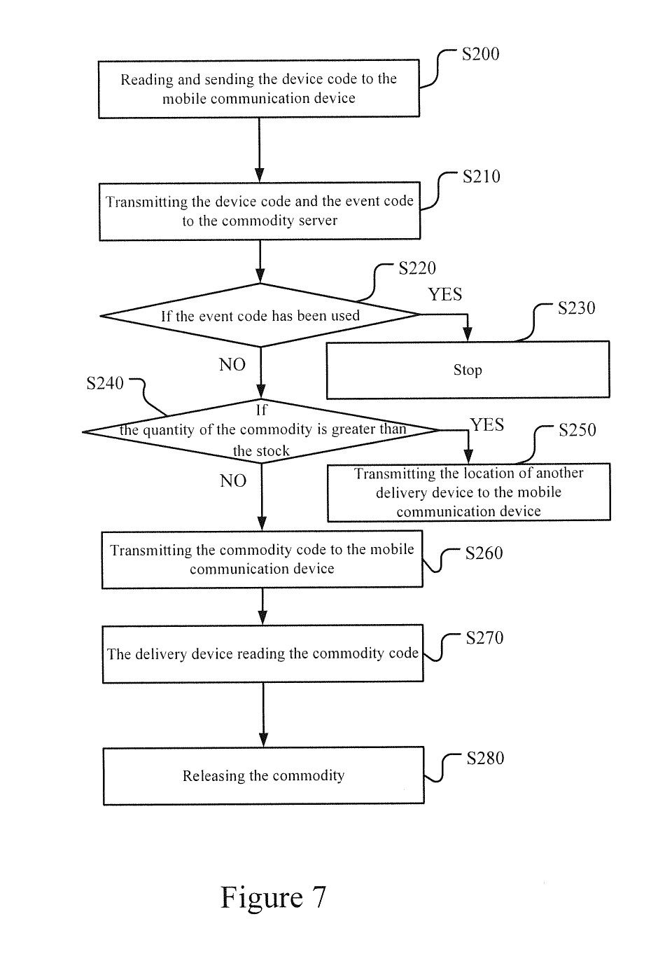

Please refer to FIG. 7, which shows a flowchart according another embodiment of the present invention. As shown in the figure, the delivery method according to the present invention is provided for people to go to a neighboring delivery device 10 for taking delivery of a non-unique commodity, instead of going to a store specially, and thus gaining convenience in taking delivery of commodities such as free movie tickets. According to the present embodiment, the commodity code is used as the delivery code NUM, which the quantity of the corresponding commodity. The delivery method according to the present invention comprises steps of:
S200: Reading and sending the device code DEV to the mobile communication device 20;
S210: Transmitting the device code DEV and the event code EVENT to the commodity server 40;
S220: Confirming if the event code EVENT has been used;
S230: Stop;
S240: Confirming if the quantity of the commodity is greater than the stock in the delivery device according the event code EVENT and the device code DEV;
S250: Transmitting the location of another delivery device to the mobile communication device 20 according to the event code EVENT;
S260: Transmitting the commodity code to the mobile communication device 20;
S270: The delivery device 10 reading the commodity code; and
S180: Releasing the commodity.

In the step S200, the mobile communication device 20 reads the device code DEV stored in the tag unit 12 of the delivery device 10. The device code DEV is implemented by an electronic tag or a graphic tag. In the step S210, the mobile communication device 10 transmits the read device code DEV, together with the event code EVENT, to the commodity server 40. In the step S220, confirm if the event code EVENT is used. When the event code EVENT is used, the step S230 is executed; if not, the step S240 is executed. In the step 230, the commodity server 40 stops operations and notifies the mobile communication device 20. In the step S240, the commodity server 40 judges if the quantity of the corresponding commodity of the delivery code NUM is greater than the stock in the delivery device 10. When the commodity server 10 judges that the quantity of the corresponding commodity of the delivery code NUM is greater than the stock in the delivery device 10, the step S250 is executed; otherwise, the step S260 is executed.

Next, in the step S250, the commodity server 40 reads the location of another delivery device according to the event code EVENT and transmits it to the mobile communication device 20. Thereby, people can know the location of another delivery device by means of the messages received by the commodity server 40. In addition, the commodity server 40 will further submit a supply notification to the vendor of the commodity so that the vendor can supply commodities. In the step S260, the commodity server 40 reads the list LIST and reads the delivery code NUM corresponding to the event code EVENT and the device code DEV for connecting to the mobile communication device 20 via the Internet 30. Besides, the commodity server 40 deducts the quantity of the commodity corresponding to the delivery code NUM from the stock. According to the present embodiment, the delivery code is just the commodity code, which is non-unique code. For example, the delivery device 10 contains 1000 concert posters. Each event code EVENT corresponds to a poster. IN other words, each commodity code corresponds to a poster. Thereby, the deduction of commodity stock is to exclude a corresponding poster of the commodity code from the quantity of posters in stock, namely, 1000, in the list LIST and leaving 999 posters. That is to say, the corresponding quantity on the list LIST is reduced. Afterwards, in the step S270, the control and processing unit 16 of the delivery device 10 reads the commodity code. Then in the step S280, the control and processing unit 16 of the delivery device 10 releases the commodity in stock according to the commodity code. Accordingly, labors used for distributing commodities can be reduced.

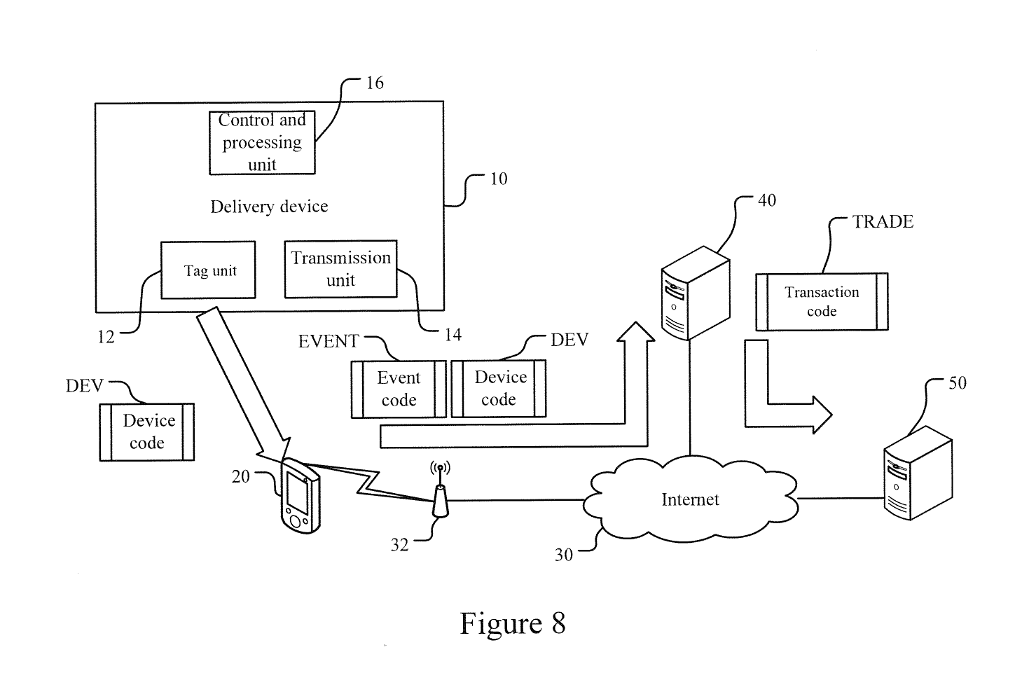

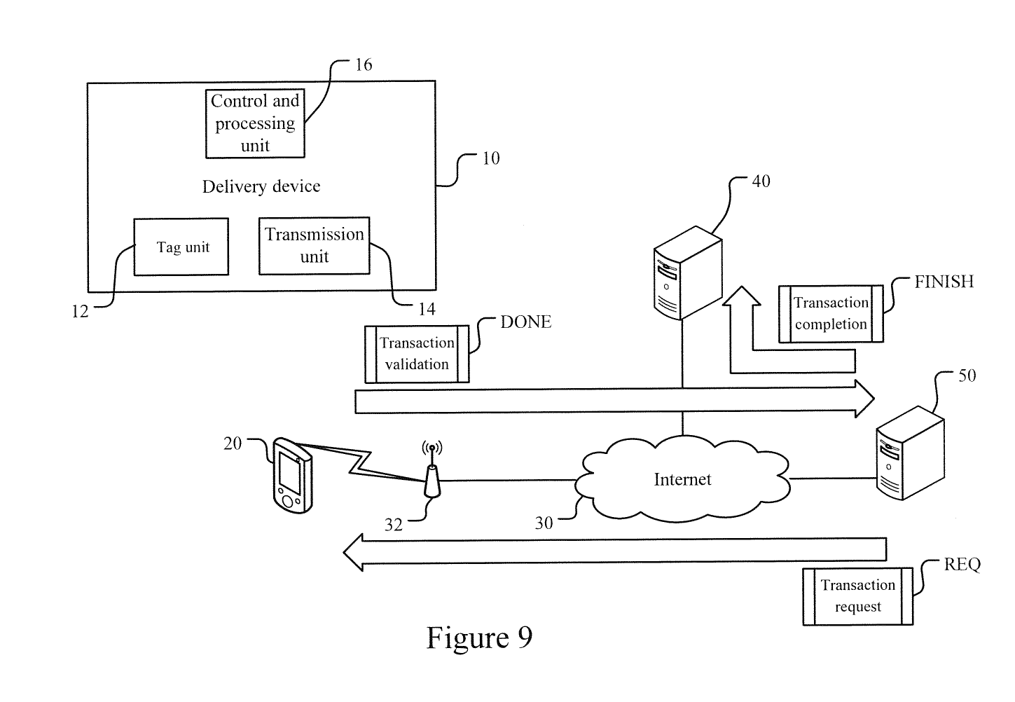

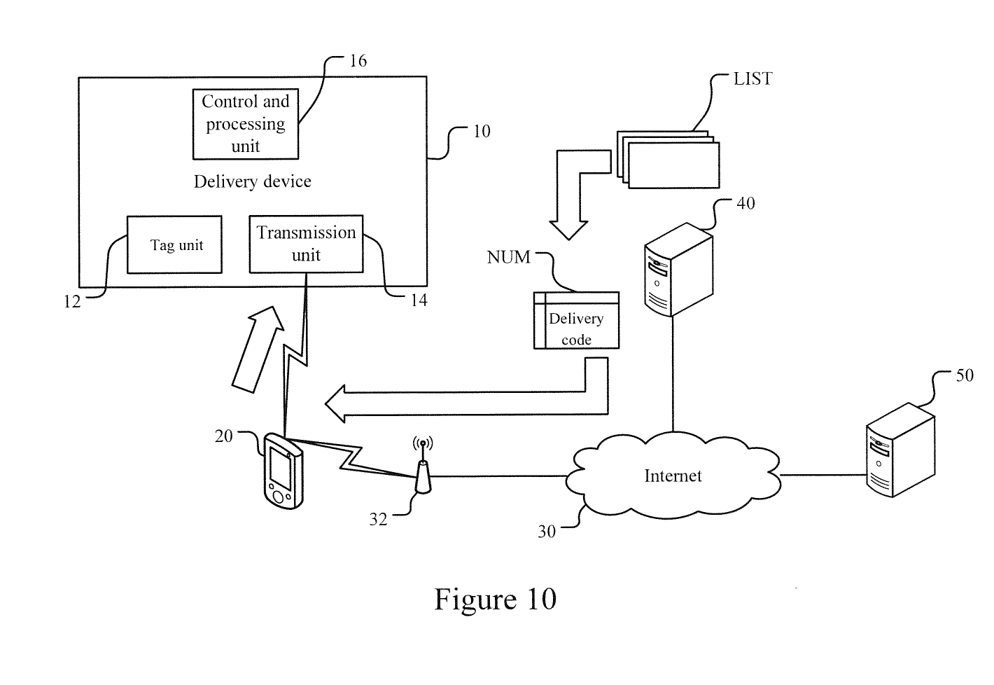

Please refer to FIG. 8, FIG. 9, and FIG. 10, which show schematic diagrams of device validation, transaction validation, and commodity delivery according to another embodiment of the present invention. The difference between FIG. 1 and FIG. 8 is that FIG. 8 further comprises a transaction server 50. In other words, the delivery method according to the present invention can be further applied to purchasing transactions. As shown in FIG. 8, the trading system for the delivery method with automatic certification according to the present invention comprises a delivery device 10, a mobile communication device 20, a commodity server 40, and a transaction server 50. In addition, the delivery device 10 also has a tag unit 12, a transmission unit 14, and a control and processing unit 16. The mobile communication device 20 is also connected to the Internet 30 via a network node 32. The commodity server 40 is also connected to the Internet 30. The commodity server 40 and the transaction server 50 are also connected to the Internet 30.

In FIG. 8, the operations that the mobile communication device 20 reads the device code DEV and transmits the device code DEV and the event code EVENT have been disclosed in the previous embodiment. Hence, in this embodiment, this part will not be repeated. After receiving the event code EVENT and the device code DEV, the commodity server 40 transmits a transaction code TRADE to the transaction server 50, triggering the transaction server 50 to execute the trading procedure according to the transaction code TRADE. In FIG. 9, the transaction server 50 then transmits a transaction request REQ to the mobile communication device 20, triggering the mobile communication device 20 to validate if transaction of the commodity will proceed. After people validate the transaction, a transaction validation message DONE, which includes payment information of the commodity, is transmitted to the transaction server 50. After the transaction server 50 receives the transaction validation message DONE, it transmits a corresponding transaction completion message FINISH to the commodity server 40. In FIG. 10, how the commodity server 40 transmits the delivery code NUM to the mobile communication device 20 via the Internet 30 for delivering the commodity has been described in the previous embodiment. Hence, it will not be described again in this description.

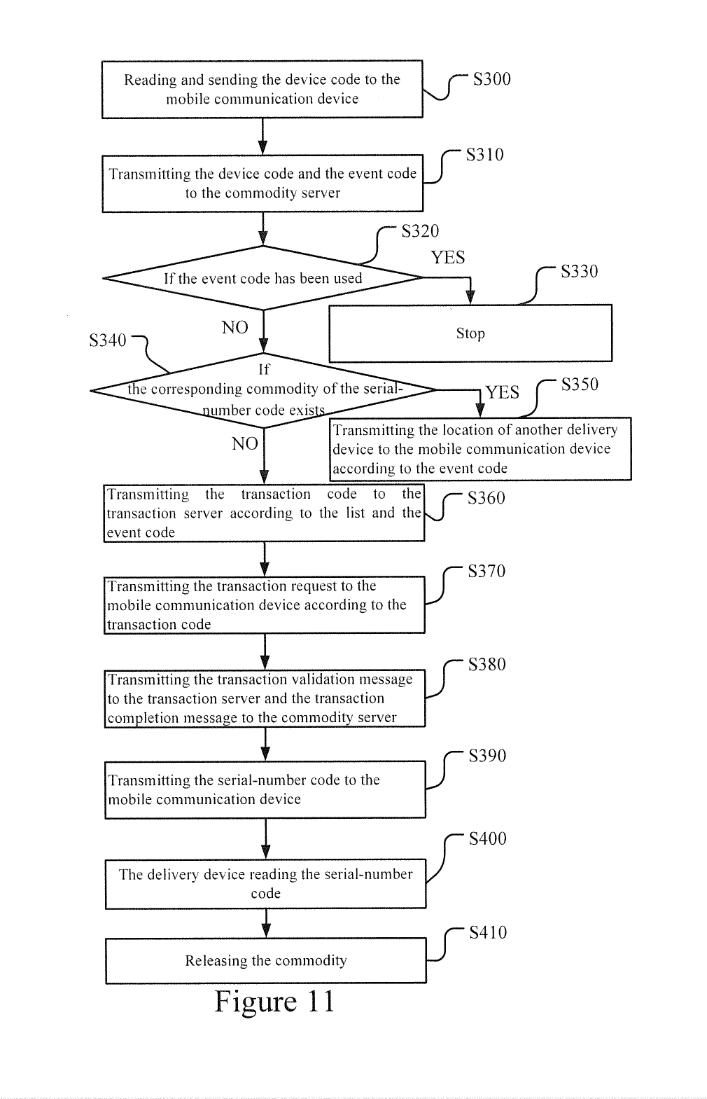

Please refer to FIGS. 8 to 11, which show schematic diagrams of device validation, transaction validation, and commodity delivery and a flowchart according to another embodiment of the present invention. As shown in the figures, according to the delivery method of the present invention, certifications for the device code, the event code, the transaction code, and the serial-number code are performed and applied to commodity transactions. For example, purchasing is implemented by certification to a commodity showcase using a mobile phone. In the present embodiment, the serial-number code is used as the delivery code NUM. The delivery method applied in transactions according to the present invention comprises steps of:
S300: Reading and sending the device code DEV to the mobile communication device 20;
S310: Transmitting the device code DEV and the event code EVENT to the commodity server 40;
S320: Confirming if the event code EVENT has been used;
S330: Stop;
S340: Confirming stock according the event code EVENT and the device code DEV;
S350: Transmitting the location of another delivery device to the mobile communication device 20 according to the event code EVENT;
S360: Transmitting the transaction code TRADE to the transaction server 50 according to the list LIST and the event code EVENT;
S370: Transmitting the transaction request REQ to the mobile communication device 20 according to the transaction code TRADE;
S380: Transmitting the transaction validation message DONE to the transaction server 50 and the transaction completion message FINISH to the commodity server 40;
S390: Transmitting the serial-number code to the mobile communication device 20;
S400: The delivery device 10 reading the serial-number code; and
S410: Releasing the commodity.

The steps S300 to S350 are identical to the steps S100 to S150 described above. Hence, the details will not be described again. In the step S360, the commodity server 40 reads the corresponding list LIST according to the device code DEV and the event code EVENT, and thus acquiring the serial-number code of the commodity to be purchased via the mobile communication device 20 by people according to the list LIST and the event code EVENT. The commodity server 40 then generates the corresponding transaction code TRADE to the transaction server 50. In the step S370, the transaction server 50 generates and transmits the transaction request REQ to the mobile communication device 20 according to the transaction code TRADE, where the transaction request REQ is the request for validation and payment for the commodity to be purchased. In the step S380, people submit the transaction validation message DONE to the transaction server 50 through the mobile communication device 20. Thereby, people use the mobile communication device 20 to submit the message of validating the payment for the transaction. Next, the transaction server 50 generates the transaction completion message FINISH to the commodity server 40. Afterwards, the commodity server 40 executes the step S390 for transmitting the corresponding serial-number code to the mobile communication device 20. Then, the mobile communication device 20 executes the step S400, in which the delivery device 10 reads the serial-number code of the mobile communication device 20. The operation of releasing the commodity in the step S410 is the same as the step S180. Hence, it will not be described further in the present embodiment.

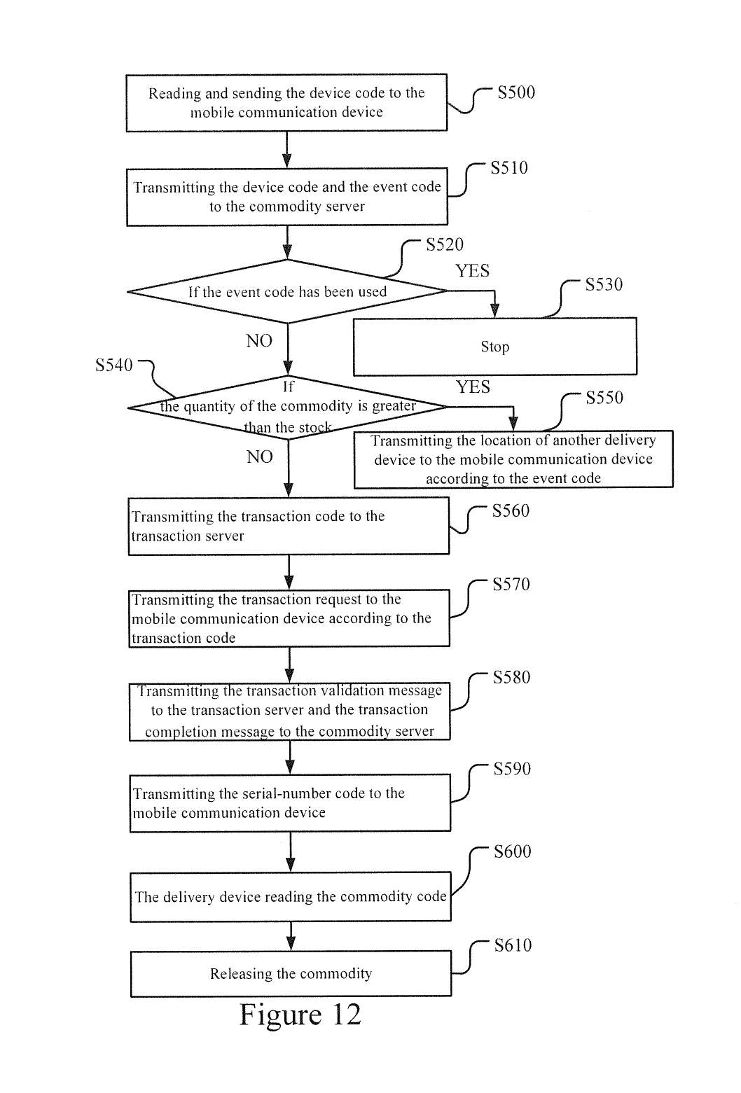

Please refer to FIG. 12, which shows a flowchart according to another embodiment of the present invention. As shown in the figures, according to the delivery method of the present invention, certifications for the device code, the event code, the transaction code, and the commodity code are performed and applied to commodity transactions. For example, purchasing is implemented by certification to a commodity showcase using a mobile phone. In the present embodiment, the commodity code is used as the delivery code NUM. The delivery method applied in transactions according to the present invention comprises steps of:
S500: Reading and sending the device code DEV to the mobile communication device 20;
S510: Transmitting the device code DEV and the event code EVENT to the commodity server 40;
S520: Confirming if the event code EVENT has been used;
S530: Stop;
S540: Confirming if the quantity of the commodity is greater than the stock in the delivery device according the event code EVENT and the device code DEV;
S550: Transmitting the location of another delivery device to the mobile communication device 20 according to the event code EVENT;
S560: Transmitting the transaction code TRADE to the transaction server 50;
S570: The transaction server 50 transmitting the transaction request REQ to the mobile communication device 20 according to the transaction code TRADE;
S580: The mobile communication device 20 transmitting the transaction validation message DONE to the transaction server 50 and the transaction completion message FINISH to the commodity server 40;
S590: Transmitting the commodity code to the mobile communication device 20;
S600: The delivery device 10 reading the commodity code; and
S610: Releasing the commodity.

The steps S500 to S550 are identical to the steps S200 to S250 described above. Hence, the details will not be described again. In the step S560, the commodity server 40 reads the corresponding list LIST according to the device code DEV and the event code EVENT, and thus acquiring the commodity code of the commodity to be purchased via the mobile communication device 20 by people according to the list LIST and the event code EVENT. The commodity server 40 then generates the corresponding transaction code TRADE to the transaction server 50. In the step S570, the transaction server 50 generates and transmits the transaction request REQ to the mobile communication device 20 according to the transaction code TRADE, where the transaction request REQ is the request for validation and payment for the commodity to be purchased. In the step S580, people submit the transaction validation message DONE to the transaction server 50 through the mobile communication device 20. Thereby, people use the mobile communication device 20 to submit the message of validating the payment for the transaction. Next, the transaction server 50 generates the transaction completion message FINISH to the commodity server 40. Afterwards, the commodity server 40 executes the step S590 for transmitting the corresponding commodity code of the commodity quantity to the mobile communication device 20. Then, the mobile communication device 20 executes the step S600, in which the delivery device 10 reads the commodity code of the mobile communication device 20. The operation of releasing the commodity in the step S610 is the same as the step S280. Hence, it will not be described further in the present embodiment. Accordingly, the delivery method according to the present invention can be applied to the trading applications of non-unique commodities. Labors can be saved in commodity distribution. Beside, the automatic certification function also facilitates correct commodity distribution.

To sum up, the present invention provides a delivery method with automatic certification, which enables people to read the device code of the delivery device using a mobile communication device. The device code and the event code are transmitted to the server for certifying the commodity to be delivered. In addition, the delivery device can validate if the commodity can be delivered according to the corresponding commodity code provided by the server. Thereby, the present invention enables people to take delivery of commodities real-timely without the problem of taking delivery or usage assuming others' identities. Moreover, the delivery method according to the present invention can be further applied to replacing the trading method.

Accordingly, the present invention conforms to the legal requirements owing to its novelty, nonobviousness, and utility. However, the foregoing description is only embodiments of the present invention, not used to limit the scope and range of the present invention. Those equivalent changes or modifications made according to the shape, structure, feature, or spirit described in the claims of the present invention are included in the appended claims of the present invention.

1. A delivery method with automatic certification, comprising steps of:
reading and sending a device code of a delivery device to a mobile communication device;
transmitting said device code and an event code to a server using said mobile communication device;
said server validating a commodity of said delivery device according to said event code and said device code, and reading a serial-number code corresponding to said commodity;
transmitting said serial-number code to said mobile communication device, and deducting said serial-number code from a stock record;
transmitting said serial-number code to said delivery device; and
matching said serial-number code according to a reference code stored in said delivery device for releasing said commodity.

2. The delivery method of claim 1, wherein said event code and said device code correspond to said serial-number code.

3. The delivery method of claim 1, wherein said event code includes a serial number of said mobile communication device or commodity information of said commodity.

4. The delivery method of claim 1, wherein said mobile communication device is connected to an electronic tag of said delivery device for reading said device code.

5. The delivery method of claim 1, wherein said mobile communication device extracts the image of a graphic tag of said delivery device using an image extraction unit for reading said device code.

6. A delivery method with automatic certification, comprising steps of:
reading and sending a device code of a delivery device to a mobile communication device;
transmitting said device code and an event code to a server using said mobile communication device;
validating the quantity of a commodity according to said event code and said device code, and reading at least a commodity code corresponding to the quantity of said commodity;
transmitting said commodity code to said mobile communication device according to said event code, and deducting the corresponding quantity of said commodity according to said event code from the corresponding stock of said commodity;
reading and sending said commodity code to said delivery device; and
using said delivery device to release at least a commodity according to said commodity code.

7. The delivery method of claim 6, where in said step of validating the quantity of a commodity according to said event code and said device code, when the quantity of said commodity is zero, said server transmits the location of another delivery device to said mobile communication device.

8. The delivery method of claim 6, wherein said mobile communication device is connected to an electronic tag of said delivery device for reading said device code.

9. The delivery method of claim 6, wherein said mobile communication device extracts the image of a graphic tag of said delivery device using an image extraction unit for reading said device code.
